(19) United States
(12) Patent Application Publication
(10) Pub. No.: US 2017/0200177 A1
(43) Pub. Date: Jul. 13, 2017

(54) SYSTEMS AND METHODS FOR PROCESSING A CASH OPTION INCENTIVE IN A FINANCIAL TRANSACTION

(71) Applicant: Ben Psillas, Chevy Chase, MD (US)

(72) Inventor: Ben Psillas, Chevy Chase, MD (US)

(21) Appl. No.: 15/403,787

(22) Filed: Jan. 11, 2017

Related U.S. Application Data
(60) Provisional application No. 62/277,183, filed on Jan. 11, 2016.

(51) Int. Cl. G06Q 30/02

(52) U.S. Cl. CPC G06Q 30/0222; G06Q 30/0238; G06Q 30/0276

(57) ABSTRACT

Software, databases, analytical processes, and a sponsor module are employed to provide a retailer payment optimization system. The payment optimization system enables the retailer to offer an incentive for using one payment method, such as cash, over a less preferred payment method, such as credit. Retailers can use the system to offer loyalty benefits, reduce transaction fees, increase net profits, maximize manufacturer allowances, increase brand value, and increase customer satisfaction and savings.

### RELATED PATENT APPLICATION

This application claims priority to U.S. Provisional Patent Application 62/277,183 filed Jan. 11, 2016, the content of which is incorporated herein by reference in its entirety.

### FIELD OF THE INVENTION

The present invention relates to a system and method for providing an intelligent rounding system for retailers to increase total consumer spend, accelerate speed of checkout, lower interchange costs, save fees, and offer consumers discounts for paying cash and/or viewing sponsors. The invention makes use of one or more computers and systems to interact with a retailer's internal transaction processing system including point of sale systems to identify opportunities to round down transaction or product item pricing to achieve whole number or logical incremental final transaction amount more likely to incentivize the consumer to pay by cash.

### BACKGROUND OF THE INVENTION

The background of the invention includes point of sale system, merchant or retailer system including smart cash register systems, credit card processing systems, and customer loyalty systems.

### SUMMARY OF INVENTION

The present invention provides a system, software, and methods for conducting financial transactions at retailers using a pay cash and save rounded down analysis and offer. The system integrates with the retailer's cash register, scanner, and point of sale system. The software enables the system to round down to a whole number or number ending in a $0.25 increment which is more likely to be selected by customers in a pay cash for a discount program. The system may integrate sponsors and advertisers who are willing to supplement all or a portion of the discount applied to the transaction amount to enable the system to round a transaction down to a whole number more likely to be selected by customers in a pay cash for a discount program.

### BRIEF DESCRIPTION OF THE DRAWINGS

The present invention can be more fully understood by reading the following detailed description together with the accompanying drawings, in which like reference indicators are used to designate like elements, and in which:

FIG. 1 is system diagram of the present invention;

FIG. 2 is a process flow diagram of the steps performed by the system of the present invention during the initiation of a transaction;

FIG. 3 is a process flow diagram of the steps performed by the system of the present invention during the rounding analysis;

FIG. 4 is a process flow diagram of the steps performed by the system of the present invention when identifying a sponsor; and

FIG. 5 is a process flow diagram of the steps performed by the system of the present invention when completing a transaction.

### DETAILED DESCRIPTION OF EXEMPLARY EMBODIMENTS

Described herein are systems and methods for managing and processing retailer transactions employing a capability to determine transactions or products capable of applying a rounded down cash price. The system of the present invention may be referred to herein as the “RoundMe” system. The RoundMe system and associated subsystems, software, and other technical aspects in accordance with various embodiments of the invention will be described. As used herein, any term in the singular may be interpreted to be in the plural, and alternatively, any term in the plural may be interpreted to be in the singular. As used herein, “customer” and “user” have been used interchangeably, as a user may constitute a customer.

### System

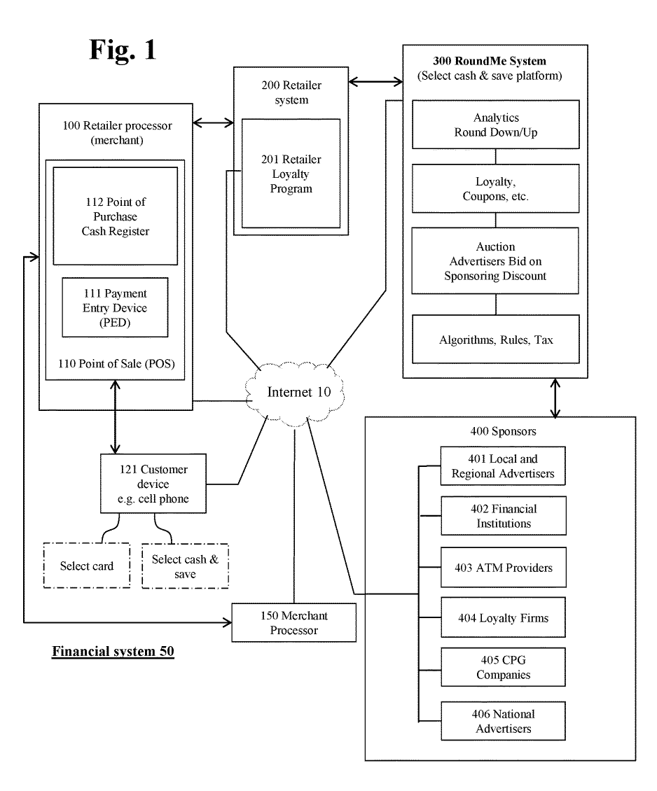

In accordance with FIG. 1, the Financial System 50 includes numerous components and parts connected through the internet 10 or through a local area network or a wide area network. The financial system 50 includes the RoundMe System or the 300 which may also be referred to as the Select Cash and Save Platform. The RoundMe System 300 includes an analytics round down component or software module, a customer loyalty and coupons component or software module, and an advertisers bid and sponsoring discount platform or auction platform. The RoundMe System 300 is connected to or works in concert with the retailer processor system 100 and the Retailer System 200. The retailer is typically a merchant such as a grocery store or chain of stores (i.e. a large consumer goods store such as a Target or Best Buy). The retailer processor system 100 may include a point of sale system 110. A point of sale system may be referred to herein as a POS. The POS system 110 may include a payment entry device (“PED”) 111 and a cash register 112. The payment entry device 111 may include functionality to offer displayed text to the consumer as well as the ability to process a credit card or debit card payment or other form of payment though the payment entry device 111. The cash register 112 or point of purchase system 112 may also display text to the consumer or cashier. The register 112 is typically used by the cashier to accept cash payment.

The cash register 112 and the payment entry device 111 may both be connected to the Retailer Processor 100 of the retailer. The customer at the retailer may use several devices to interact with the system 50 to view a sponsor ad, make a credit payment, or to select a lower cash payment. The system can be utilized to incentivize any lower payment form over a higher payment form. Throughout this description of the present invention, cash is used as the lower payment form and credit is used as the higher payment form. However, the system can handle any payments and the comparison and analysis between payment forms which may include cash, a credit card, a debit card, Bitcoin, prepaid cards, gift cards, direct debit, bank transfers, phone and mobile payments, checks, money orders, or any other form of payment. Such payment may be made through a credit card or through a customer's device 121 such as a cellphone or smart device which may be connected to the user's credit card, bank account, and Bitcoin account. The customer's device 121 and the retailer processor 100 are connected to each through use of internet or wide area network communication or mobile communication. The financial system 50 also includes a retailer system 200 which often includes a retailer loyalty program 201. Additional aspects tied into the Financial System 50 may include the Sponsor System 400 which may include local and regional advertisers 401, financial institutions 402, loyalty firms 404, CPG (Consumer Packaged Goods) companies 405, national advertisers 406, and ATM Providers 403. The RoundMe System 300 may be connected directly to the Retailer System 200, Retailer Processor 100, or the Sponsor System 400 within a closed system such as all on one processor based device, such as a server, utilizing one or more software applications, or within a local area network. Alternatively, the RoundMe System 300 may be connected indirectly to the Retailer System 200, Retailer Processor 100, or the Sponsor System 400 such as through the internet 10. In use, the retailer processor 100, including the point of sale system 110, interact at the time of transaction to enable the customer to make payment for the goods through cash or through the point of sale terminal 111.

When a consumer selects to use credit or debit through the point of sale terminal 111, the retailer and the point of sale system 110 are connected to one or more transaction systems. The transaction systems process the payment by conducting an electronic funds transfer (EFT) or ACH transaction which transfers money from the purchaser's bank account, bitcoin, rewards, loyalty or credit card account. The EFT transactions are typically connected to large credit card company such as a Visa and a MasterCard and often include a fixed percentage fee of (2-3%) two to three percent of the transaction price plus a transaction fee. Thus, in a $100 product purchase the retailer pays $2-$3 in transaction fees to the companies running the point of sale system 110, any additional transaction processors, and the credit companies like Visa and MasterCard which process the payment or provide credit to the consumer. The majority of the point of sale transaction fee often goes to the issuer of the credit/debit card. However, the present invention enables the retailer to avoid some or all of the fees if cash is selected and used to pay for the goods. Thus, the payment of cash often saves the retailer significant fees which could boost the retailer's net profit.

Additionally, one of the benefits of conducting a purchase with a credit card or debit card is the ability to not need to carry large amounts of cash and especially coins on oneself to handle transactions. However, consumers often carry certain cash amounts with them and prefer, to not carry large amounts of coins. Consequently, when a consumer is presented the final price for the purchase of goods including all taxes find that if the purchase price is not close to a whole number the individual is less inclined to pay with cash as a means to avoid having large amounts of change (coins) provided. Therefore, the consumer is more likely to use credit and less likely to pay cash meaning the retailer ultimately is receiving fewer and fewer transactions that are cash based and increasing the amount of money that they are paying to the transaction process providers.

The RoundMe System 300 provides a system and software which enables a retailer to encourage or incentivize the consumer to pay cash thereby saving the retailer additional fees in the merchant transaction while also saving the consumer money. During a transaction, the RoundMe System 300 uses the analytics module to analyze and determine optimal transactions which are likely to provide an opportunity to round down the transaction. Specifically, the system is ideally employed when the total amount for a given transaction is close to a whole number, or logical incremental amount (i.e. rounding to the nearest 25 cent increment), and the transaction fee paid to the issuer is greater than the amount above the whole or logical incremental number. In such instances, the retailer can recommend a savings to the consumer to select cash and pay the lower whole number in a cash transaction instead of the full amount in a credit transaction. For example, if the total transaction price for the products and taxes equals $9.07, the transaction fees would equate to approximately $0.28. However, if the individual were to pay cash, the retailer would not need to pay the transaction fees and it would save approximately $0.28. However, the consumer is less likely to pay cash because the consumer would receive $0.93 (i.e. three quarters, one dime, one nickel, and three pennies) in change. If the retailer offered a $0.07 discount to the consumer as a benefit for paying cash, the consumer would not need to receive any change and would only pay the $9.00. The retailer would receive $9.00 but does not have to pay the $0.28 in merchant transaction fees. Ultimately, the retailer earned 20 additional cents on the RoundMe transaction over a credit transaction. However, the retailer can elect to employ the system even if they are not earning additional value such as might be used for a loyalty customer incentive or benefit.

In addition to retailers, the RoundMe System 300 may be employed by sponsors and advertisers to further incentivize the consumers to select a preferred payment option over an a credit transaction. The sponsors might include a national advertiser, such as Coca Cola, who would pay all or a portion of the amount needed to round down the total transaction to a whole or logical incremental number. The sponsor would pay the discount in exchange for an opportunity to sponsor the transaction as part of its marketing and branding activities. In such instances, the sponsors' brand, message, or ad would be displayed at the point of sale terminal or another device (i.e. the consumer's mobile device). The consumer would be prompted to select cash and save with a message that the select cash and save promotion is being sponsored by the advertiser (i.e. Coca Cola). Therefore, the consumer receives a branding impression that his transaction has been sponsored by a specific product company knowing the consumer would be appreciative of the opportunity to save $0.07.

Further the system can be used to incentivize an additional purchase at the point of sale transaction. For example, if the transaction amount was $9.07 as previously suggested, Coca Cola could recommend to round up the total transaction to $10.00 by suggesting to the consumer that they could add on a certain product to their transaction which would exceed the next whole round number based upon the typical value of the product recommended, but would then be rounded down to the higher whole number. For example, if the transaction was $9.07, Coke could offer to include a bottled Coca Cola beverage in the transaction. The incentivized product might normally retail for $1.35 which would take the non-discounted price up to $10.42. However, Coke would enable the total transaction or that specific product to be discounted down to meet the next whole number. In this instance, the Coke product would be rounded down to $0.93 including tax to get to a rounded whole number of $10.00. Effectively, Coke is instructing the retailer to complete the transaction at $10.00 with our product included and we will make sure that the retailer receives the full $9.00 they were expecting to receive as part of the original transaction. In such instance, the retailer has managed to move additional product, has seen a savings because no credit transaction fee was incurred, and the consumer received a benefit or bargain on their transaction through the sponsor. The sponsor may be a national retailer or local establishment or product provider.

### Process

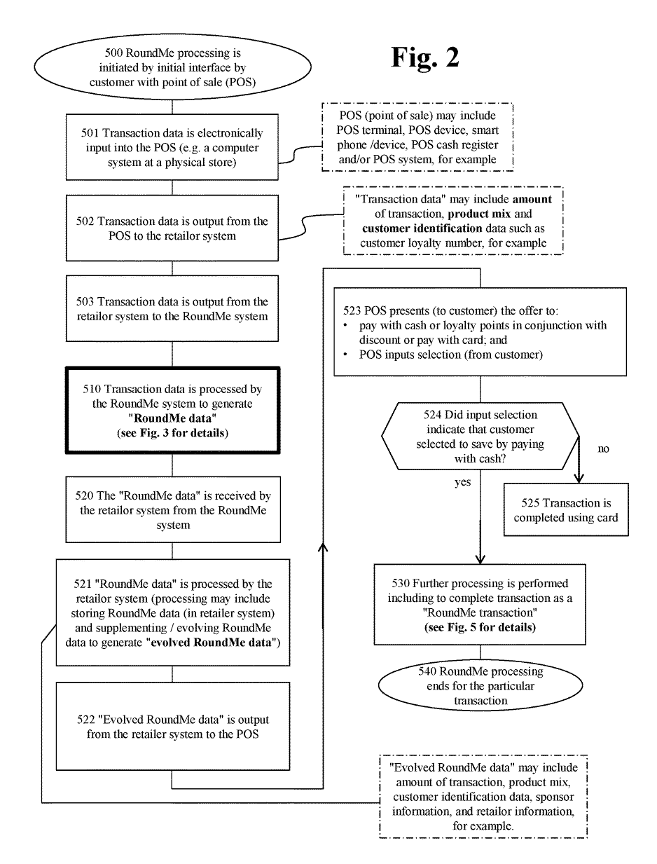

In accordance with FIGS. 2 through 5, the system will now be described in conjunction with the process flow of a transaction through the system of the present invention. In Step 500, the RoundMe Processing is initiated by initial interface with the customer at the cash register or point of sale. The process is initiated as a single product or string of products that are scanned at the register (or scanner connected to the register or scanned by a consumer's mobile device). As a product is scanned, information about that product is captured by the system through the scanning device. In Step 503, that transaction data is output from the retailer's system to the RoundMe System. The capture and transmission may be as each product is scanned or at the end of the sub-total of the transaction. The product and transaction data is electronically sent to the RoundMe Processing System for determination by the application of the rules, analysis, and rounding protocol. The transaction and product data may include the amount of each product, the amount of the total transaction, the product mix, the customer identification data such as a loyalty number and other relevant data.

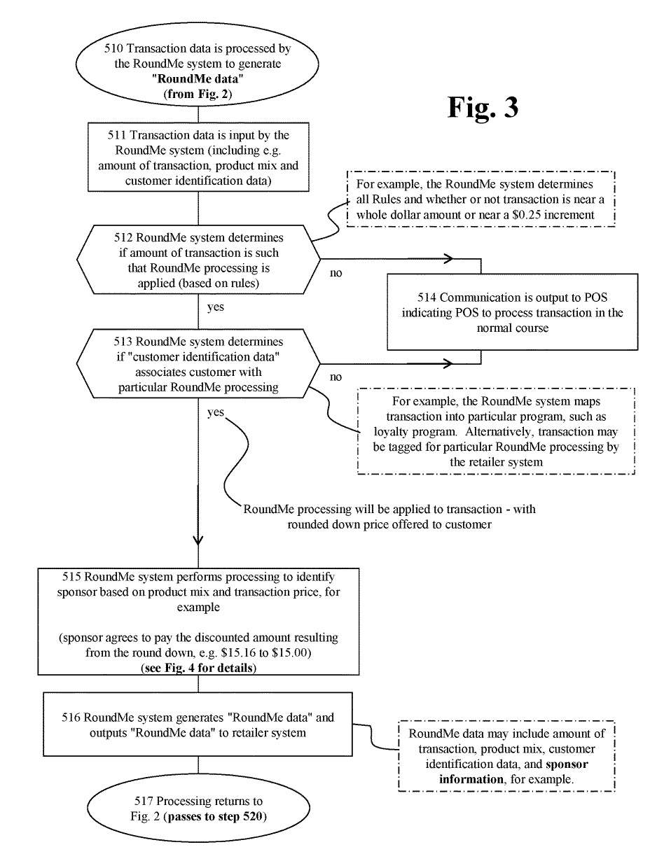

In Step 510, the transaction data is processed by the RoundMe System to generate the RoundMe data. The RoundMe data process is further detailed in the discussion as it relates to FIG. 3. In Step 520, the RoundMe data is received by the retailer's system back from the RoundMe system. The RoundMe data is processed by the retailer's system which may include storing the data and/or supplementing or evolving the data to generate evolved RoundMe data. The evolved or transformed RoundMe data is output from the retailer or from the RoundMe system directly to the point of sale system for presentation to the customer. The evolved RoundMe data may include the amount of the transaction, the product mix, the customer identification data, sponsor information, retailer information, the discount or offer, and other relevant information related to the transaction, customer or retailer.

In Step 523, the point of sale terminal, which may include the point of sale device or the user's mobile device, presents the offer to the customer. The offer may include the option to pay with cash or loyalty points in conjunction with a discount to a lower whole or logical incremental number, or to pay with a credit card without a discount. The user inputs their selection into the point of sale system or smart device. In Step 524, the system determines if the customer input the selection to save by paying with cash. If the customer did not select cash and selected to use their credit card or swiped their card, then in Step 525 the transaction is completed using the credit card and NO discount is provided. However, if the customer selected to save by paying with cash, then in Step 530 the system further processes the transaction to complete the transaction as a rounded transaction. Typically, the transaction is rounded down to save the customer money. In Step 540, the RoundMe processing ends for that particular transaction.

The details stemming from the processing of transaction data by the RoundMe System are further described in conjunction with FIG. 3. In Step 510, the transaction data is received and processed by the RoundMe Analysis software which generates RoundMe data. In Step 511, the transaction data is input by the RoundMe System which may include the amount of the transaction, the product mix and customer identification data. In Step 512, the RoundMe system determines if the amount of the transaction is such that RoundMe processing should be applied based on rules. Those rules may be rules established by the retailer or rules established by the RoundMe system, or both. Retailer rules may include such things as a list of restricted or prohibited products which are not eligible for a discount or promotion as well as limits on available discounts. Such items could include lottery tickets, alcohol, gas, or other products they want to limit in the RoundMe system. Based on the received transaction and product data, the RoundMe system determines whether to exclude any products which are restricted by the rules. Further, the system determines if the transaction is near a whole dollar amount or near a logical increment (i.e. a $0.25 increment). The system also determines the exact or estimated transaction fees based on input from the retailer on their transaction data, or the system is integrated into the POS system 110 and the PED 111 to automatically calculate or determine the transaction fees over time. The system then applies the rounding rules to one or more products. The rounding may be determined sequentially on a product by product basis or as an accumulative amount at the end. The system also determines the amount required to round down the transaction to a whole dollar amount or the nearest 25 cent increment. The system employs various rules and an algorithmic scoring system to determine whether a lower cash transaction is available and the amount of the discount for a given transaction. By way of example, a retailer employing the system could set or adjust the variables in the scoring system or rules such that under $25 the round down increments would use $0.25 cents; from $25-$75 the round down increments would use $0.50 cents; and from $75-200 the round down increments could use increments of $1.

In addition to the loyalty programs and benefits that retailers can use or employ through the system, retailers also have access to back-end consumer product and good allowance dollars. Such allowances are often offered or provided by the product makers or Consumer Packaged Goods companies to enable the retailer to market and sell certain products. Through the present invention, retailers can integrate the goods associated with the allowances to enhance or increase round down values and opportunities. Retailers can also integrate the allowance values to allow the system to more accurately monitor and integrate retailers the ability to maximize the allowance while tying the allowance directly to the manufacturer's products.

If all products scanned are excluded from rounding due to the one or more rules, if the transaction amount is not conducive for rounding, or if the retailer only wants to provide the cash discount to registered customers within their loyalty program and the current customer is not in their loyalty program, then the system may not offer a cash discount and the transaction would occur without a discount as seen in Step 514.

However, if the RoundMe system determines a rounded discount can be provided then in Step 513, the system determines if the customer or the customer's identification data is associated with the retailer's loyalty program or with the RoundMe user program. Although the system can apply the rounded discount to any user, the retailer may want to limit such transactions. Provided the system receives verification to apply the discount, the system analysis is applied or other special incentives may be applied. For example, the RoundMe System may map the transaction into a particular program specifically for that retailer such as a loyalty program. The loyalty program may offer incentives and/or track the customer's interaction with the retailer such that the amount of discount the system is willing to apply to the rounding formulation may be greater or smaller based on several factors. Those factors may include the amount the loyal customer spends with the retailer or the last time customer used a save with cash transaction. Alternatively, transactions may be earmarked for particular RoundMe processing based on the products, product mix, or other aspects of the transaction. If the products scanned are eligible for the RoundMe processing then the RoundMe system and the rounding formulation will be applied to the transaction as a whole or to the individual products and the pay cash and save is offered to the customer.

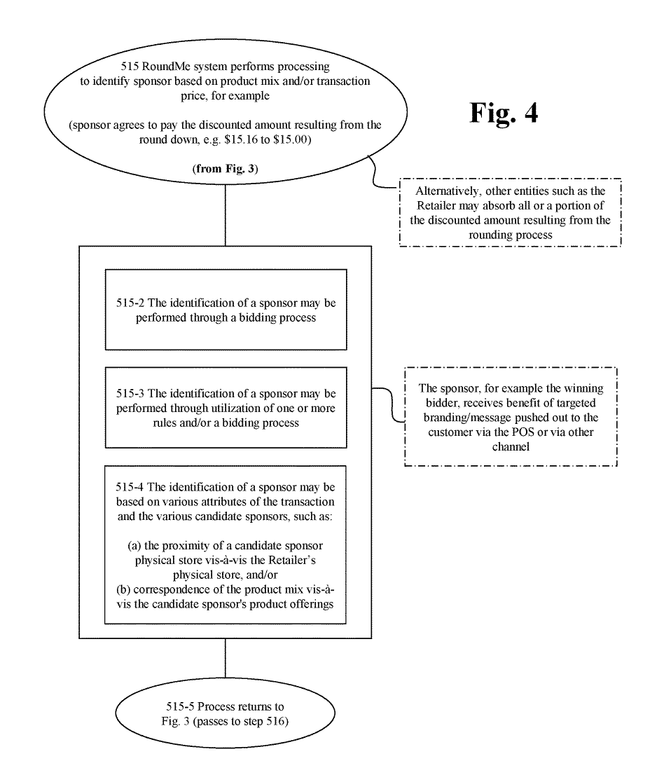

In Step 515, which may be performed before or in parallel with one or more of the previous steps, the RoundMe system performs processing to identify if there is an identifiable sponsor based on the product mix and transaction price for the particular transaction. Specifically, if the sponsor based module of the system is employed, the system determines if a particular sponsor has agreed to pay or contribute all or a portion of the discounted amount enabling the rounded down price. The sponsor processing steps will be further described below in conjunction with FIG. 4.

In Step 516, the RoundMe system has determined the rounded down offer and generates the RoundMe transaction data and outputs or transmits the RoundMe data to the retailer's system. The RoundMe data may include the amount of the transaction and the product mix, the customer identification data, the sponsor information, the sponsor message, the discount amount, and any additional offers. Such offer may be transmitted directly to the retailer, the PED 111, or the user smart device for selection by the user to pay cash and save. In Step 517, the processing returns back to Step 520 as seen in FIG. 2.

As identified in Step 515 of FIG. 3, the RoundMe system processes various rules and analysis as products are scanned or as the total transaction data is accumulated and transmitted to the RoundMe system. As seen in FIG. 4, Step 515 is expanded to provide a more illustrative description of the sponsor process. As seen in FIG. 4, Steps 515-2 through 515-4, a sponsor is identified through one or more processes. In step 515-2, the system may employ a sponsor auction program which identifies sponsor through a high bidding process. Such bidding process would enable sponsors or advertisers to offer discounts up to certain discount amounts, certain total transaction amounts, product mix and other aspects of the transaction. Higher bidding by the sponsors would enable the retailers to offset discounts they might apply to avail themselves of the transaction fee savings.

In Step 515-3, the identification of a sponsor may be performed through one or more rules, including proximity of the sponsor to the retailer or customer, sponsors related to the product scanned, or to a sponsor through ranking based on a sponsor bidding process or system. In Step 515-4, the identification of a sponsor may be based on various attributes of the transaction, the retailer, or the customer such as the proximity of a sponsor to the retailer's physical store or the customer, or related to a product that was scanned or a product offering. The sponsor may be identified as a key sponsor of the retailer or as a key sponsor for a given location. The sponsor for a given transaction may be the winning bidder and may provide a benefit to the retailer or customer through a targeted branding message pushed out to the customer via the point of sale or other channels such as a mobile device.

In operation, the form of a given transaction can be tailored to a given retailer or a given sponsor. For example, if a customer at a given retailer is in close proximity to a potential sponsor, the sponsor may work with the retailer to run and post ads to particular customers or at particular times of the day. For example, a local restaurant may want to sponsor transactions between 5-7 pm at night at a grocery store for customers who have frozen entrees in their product mix knowing those customers may be in need of dinner. Alternatively, major brand sponsors may identify products they would like to associate with to prompt a customer to think about buying additional products before they leave the store. For example, if the system identifies that the products being scanned appear to be products typical of a party such as chips, crackers and cheese, a sponsor like Coca Cola may want to sponsor the rounded down cash purchase option as a means to remind the customer that they may want beverages with their purchase. In operation, if the system was tied to a customer's loyalty program, they may be able to identify that the given customer has purchased numerous products from the sponsor in past transactions. For example, the system interacting with the loyalty program may identify that the consumer has purchased Coke products 80% of the time that they purchased chips and crackers. Integration of such customer data enables smarter and more appropriate messaging for the sponsors. In Step 515-5, the sponsor determination is complete and processing returned to Step 516 of FIG. 3.

Although in FIGS. 3 and 4 a sponsor is indicated, a sponsor is not necessary for the system to perform. In such instances, the retailer may determine to provide the discount directly to the customer without a sponsor. Retailers are accustomed to paying transaction fees often ranging between 2-3%. Therefore retailers may be incentivized to round down to a cash option if the 2-3% transaction fee equates to more than the amount required to round down. For example, if the applicable products in a given transaction total $20.36 with a 2.5% transaction fee to the retailer would result in a transaction cost of approximately $0.51. However, if the retailer wanted to save the transaction fees, they could offer a cash price of $20.00 knowing they could easily absorb the discount within the saved transaction fees. For this example, if the customer elected to pay cash and save, the $20.00 cash payment represents a net savings of $0.15 stemming from the saves transaction fees less the discount provided ($0.51-$0.36). Large retailers with significant numbers of transactions can save considerable fees by repeating this process to increase total net profit.

Still further, the system of the present invention can use the round down payment program to offer incentives. Such incentives may include options to include additional products. If the system determines the total cumulative price falls outside of the ideal transaction values for rounding down, the system may identify a particular product which could be added to the transaction allowing it to exceed the next whole or incremental number but within the parameters that would enable the total price to be rounded down. For example, if the total accumulative price was $19.73, the system might determine that they have no sponsors and the retailer is not interested in offering a rounded down amount. Since the rounded down price would be $19.50 it may not be a price consumers like or have historically selected the pay cash and save option. However, the system through analysis of its historical transactions and product pricing and discount amounts can determine that by adding a single can of Coca Cola or Pepsi to the transaction would allow the price to jump over $20.00 (i.e $20.38). However, at the higher price, they now know that Coke is willing to sponsor the rounded down program pushing the updated transaction amount ($20.38) down to the rounded amount ($20.00). In this example, the consumer could add a $0.65 soda which gets rounded down to $20 making the consumer feel as though they are getting a soda for a significant bargain. Therefore, it feels as though it is sponsored by Coke and allowing the consumer to purchase a product as part of a rounded up transaction.

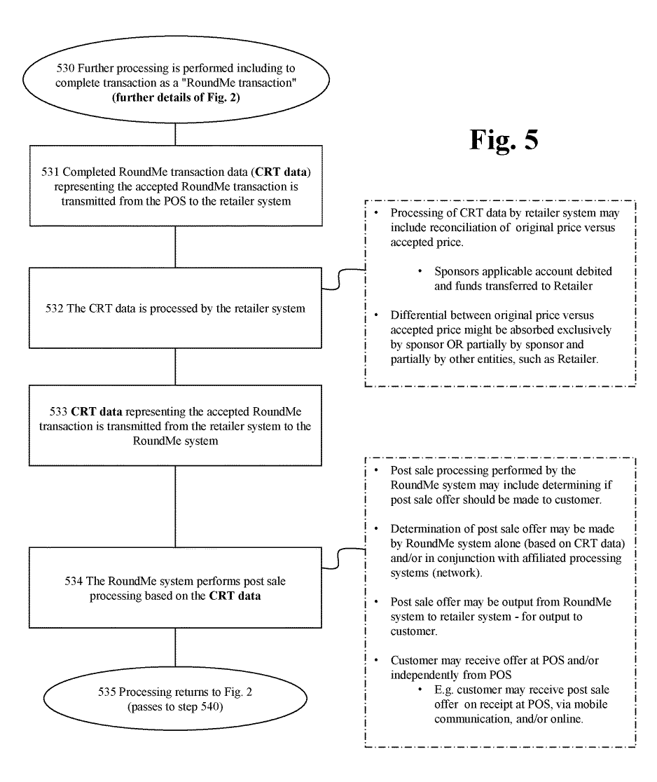

As previously discussed in FIG. 2 Step 530, additional processing is performed by the system to complete the RoundMe transaction or after completion of the transaction. FIG. 5 provides further details on these steps. In Step 531, the Completed RoundMe Transaction data (hereinafter “CRT” data), represents the accepted RoundMe transaction which is transmitted from the RoundMe system back to the retailer's system. In Step 532, the CRT data is then processed by the retailer system. The processing of the CRT data may include the reconciliation of the original price reconciled against the accepted and discounted price. The discount may entail discounting the price of the goods, or applying a coupon or other loyalty points against the discounted amount. Further, the CRT data may include which sponsor is associated with the discount and debits the discounted amount from the sponsor account or adds the discounted amount to a sponsor balance. The discounted or rounded down price may be absorbed exclusively or wholly by the sponsor, partially by the sponsor and the retailer, or solely by the retailer. Further the CRT data may include other third parties such as the point of sale terminal company to the extent such discount determination includes a solution determined by those parties.

In Step 533, CRT data representing an accepted RoundMe transaction is transmitted from the retailer system back to the RoundMe system for further processing. In this instance, the customer has accepted the rounded down cash transaction and the data around such acceptance is captured by the system and transmitted back to the RoundMe System for additional processing and/or to determine if there are any additional offers. In Step 534, the RoundMe system performs this post-sale processing based on the accepted CRT data. The post-sale processing may include determining if there are any additional offers which could be made or should be made to the customer. For example, if the rounded down cash discount was sponsored by Pepsi, Pepsi may provide a coupon or incentive to the customer which may be used on the next purchase. Additionally, post-sale offers may be made by the RoundMe System alone and the offer may be posted to the customer on the point of sale device, a post-sale receipt, or to the extent that the customer is using their own mobile device to the mobile device. In Step 535, the RoundMe System has completed post-transaction processing and the system returns to Step 540 in FIG. 2 which ends this particular transaction. By way of example, the post-sale offer could be presented via the cash register receipt or through the user's mobile device and could include a coupon for a can of Pepsi for $1.00 including tax. The actual price may be $1.26 but given the consumer has a history of using cash and save, they are more likely to use the receipt, pay with cash and receive the discount.

### Payment Entry Device

The PED 111 is the customer/consumer-facing device that allows payment choice and card entry from the consumer. PEDs 111 can be a standard terminal, a tablet device, a smart phone, and the payment entry application (“PEA”) running on the device. The merchant's relation system includes the retail POS device or RPOS. The RPOS can handle many store or merchant focused functionalities including: line item scanning, pricing, taxes, sales reporting, inventory tracking, and other personnel-related activities (clerk/waiter/cashier/employee/secure sign-in, and function privilege levels to execute certain commands). In a restaurant system, the RPOS can handle functions such as table assignment, tip tracking, and related.

An example of a smart PED 111 which can be utilized in the system is the MX 900 Series by Verifone. The MX 900 Series is a programmable PED 111 which can display graphics including videos or advertisements; and can display screen forms which can be pre-loaded. These forms or templates have text fields which can be updated in real time and well as updating logos and graphics. In application, the RPOS can send one or more codes or instructions to the PED. The codes would include an ID/key value which is used to select the graphics form or template; an optional sponsor or logo ID value or an actual logo graphics file. The RPOS can also send descriptive or explanatory text of the round down offer as well as a selection or choice number, associated with the options available, which are presented to the customer. Upon customer selection, the choice or selection number would be transmitted from the PED 111 back to the RPOS 110.

In operation, as products are scanned or “rung up”, the RPOS 110 interacts with the Retailer system 200 and the RoundMe System 300 to identify products and pricing which warrant a round down transaction. Additionally, the system 50 may wait until all products are scanned to identify products and pricing which warrant a round down transaction. The system determines a round down transaction is available through interaction of the Retail System 200 and the RoundMe System 300, which can occur on the same computer platform or separate systems located locally or remotely. The RoundMe system 300 including the software returns an indication of the transaction results which triggers a push notification to the PED 111 to display the results to the consumer. The notification and display on the PED 111 provide the user one or more choices about the payment method, discounted incentive product purchase, a charitable donation; or other like offers. The RoundMe results are displayed on the PED 111 with defined input buttons associated with the offers. The consumer selects the payment or offer option they desire which is then passed from the PED 111 back to the retailer system 200. The retailer system 200 processes the user's choice and either directly handles the cash payment or it launches the credit or debit transaction to the payment processor.

The Retailer System 200 and RoundMe System 300 work in combination to adjust pricing in real time. By way of example, when a consumer chooses the RoundMe rounded down transaction through the PED 111, the selection is passed back to the Retailer System 200. The Retailer System 200 and Retailer processor 100 then change the current total price in the system to the new rounded down price. This rounded down price may be applied, evenly or unevenly, to all products or to one or more identified products in the consumer's total purchase. Such selection by the user automatically adjust the price in the system, which then can transmit a final price to the cashier or cash register without the need for the cashier to enter any discount codes, enrollment or similar steps. Further, once the rounded down transaction has been completed, the RoundMe System 300 and related software resident on the RoundMe System reconciles the discount with any corresponding coupon, sponsored advertisement with the retailers accounting system, which is resident on or connected to the Retailer System 200, thereby ensuring the Ped 111, the POS system 110, the cash register 112, and the entire Retailer System 200 and processor system 100 are balanced.

### Matrix and self-learning analytics

An important aspect of the system of the present invention is the analytics and smart learning module. The analytics module records historical transactions and determines optimal price points where customers are most likely to select the pay cash and save option. The system tracks and analyzes the amount of the total transaction and how close it is to a whole number or a logical incremental number. The system can determine and estimate the probability of the pay cash and save transaction being selected. Through self-learning or the use of machine learning analysis, the system can help a retailer determine real-time incentives and discounts to promote the pay cash and save program. Further, the system can help to identify products that trigger more cash transactions and can identify suggested price changes for certain products. Through the analytics software, the system can also identify products for the round up transaction and process discussed above.

### Credit Card Incentives

The present invention could also be used by credit card companies to incentivize consumers to use a particular credit card over another. In operation, the system would process the items to be purchased and follow any rules. As describe above, those rules may limit the application of discounts on certain products or items (i.e. lottery tickets or gas). However, once the products or total transaction price is determined, the system would determine the transaction fees as compared to a discount or sponsored amount needed to reduce the transaction to a rounded down whole number or logical interval. As an alternative to a sponsor or if the system did not identify a sponsor willing to sponsor the round down, the system would allow the credit card companies to provide or sponsor the discount using their card. For example, if a transaction total was $20.36 cents using any payment method, the system would allow the credit card companies to bid to provide the lowest transaction fee or allow each credit card company to propose an offer for the customer to choose. For example, Visa and MasterCard may each offer to discount the transaction down to $20.25 while Discover is willing to discount the transaction down to $20.00. The system may integrate with the customer's loyalty account at the retailer or with the RoundMe system to know which credit cards the user employs. The user's actual credit card companies may compete for the transaction. By way of example, the user's Citi Visa card offers the first incentive (i.e. $20.25) while the user's Chase Visa card offers a second incentive (i.e. $20.00).

### Charitable Contributions

The system could also be utilized by retailers to offer an opportunity for the customer or the retailer to support a charity. The charity may be one the customer chooses or one the retailer chooses. In operation, the system would process the items to be purchased and follow any rules. As describe above, those rules may limit the application of discounts on certain products or items (i.e. lottery tickets or gas). The charitable aspect works best when the product total is a considerable sum. In operation, the system would determine the total amount of the transaction and determine the next logical whole number or logical interval. The system would then allow the user to pay cash with a charitable donation added as an additional incentive. For example, if the total transaction price for a credit transaction was $30.24 cents, the retailer would pay approximately $0.83 cents (2.5% in transaction fees). However, the retailer or sponsor only needs to provide a $0.24 cent discount to achieve a $30.00 whole rounded down number. However, the retailer or sponsor could further incentivize the customer to choose the pay cash option by offering to match the discount with a donation to a charity. In the provided example, the retailer or sponsor would donate $0.24 to a charity in addition to the $0.24 discount to bring the cash amount to an even $30.00. The retailer's total discount to the customer and contribution to the charity is $0.48 cents which is still less than the $0.83 cents in transaction fees. Through use of the present invention, the retailer is able to provide significant benefits to the consumer, charitable organizations, and to their own profits.

It is appreciated that features of one embodiment as described herein may be used in conjunction with other embodiments.

The described embodiments may be implemented as a system, method, apparatus or article of manufacture using standard programming and/or engineering techniques related to software, firmware, hardware, or any combination thereof. The described operations may be implemented as code maintained in a “computer readable medium,” where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code performing features of the invention may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention, the systems and methods use networks, wherein, the term, ‘networks’ means a system allowing interaction between two or more electronic devices, and includes any form of inter/intra enterprise environment such as the world wide web, Local Area Network (LAN), Wide Area Network (WAN), Storage Area Network (SAN) or any form of Intranet.

In embodiments of the invention, the systems and methods can be practiced using any suitable electronic device, i.e. a processing machine, which is provided with instructions to implement embodiments of the invention. An electronic device for the purpose of this invention is selected from any device capable of processing or representing data to a user and providing access to a network or any system similar to the internet, wherein the electronic device may be selected from but not limited to tablets, personal computers, mobile phones, laptops, palmtops, portable media players and personal digital assistants.

As noted above, the processing machine used to implement the invention may be a specialized computer or other processing machine. The processing machine may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the various steps of the processes of the invention.

The processing machine used to implement the invention may utilize a suitable operating system. Thus, embodiments of the invention may include a processing machine running the Windows™ 10™ operating system, the Windows™ 8™ operating system, Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform. It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner and/or in communication with each other in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, as also described above, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, as also described above, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

What is claimed is:

1. A computer system that performs roundme processing including inputting human user selections over an electronic network, the system includes a processor configured to execute computer program instructions disposed on a database portion, the processor in the form of a computer server that is in communication with the network, the system comprising:
(A) the database portion; and
(B) the processor, and
the processor performing the roundme processing including:
inputting transaction data of a transaction performed by the human user at a point of sale, the transaction data including transaction product mix and initial transaction amount;
processing the transaction data to generate roundme data;
based on the roundme data, interfacing with the human user to present selection options, the selection options including (a) an option to pay with cash, and (b) an option to pay with electronic payment mechanism;
inputting a selected selection, the selected selection being the option to pay with cash;
based on the roundme data, determining a transaction sponsor for the transaction, including:
comparing sponsor attributes, of a plurality of potential sponsors, vis-à-vis the transaction data;
determining an affiliation level of each of the plurality of potential sponsors vis-à-vis the transaction data;
determining the potential sponsor having the highest affiliation level, and tagging such potential sponsor as a selected sponsor; and
outputting content, unique to the selected sponsor, to the human user; and
based on the selected selection, interfacing with the human user to present a reduced transaction amount as compared to the initial transaction amount, and
inputting payment in cash from the human user of the reduced payment amount.

2. The computer system of claim 1, the determining an affiliation level of each of the plurality of potential sponsors vis-à-vis the transaction data includes:
determining a transaction physical location of the transaction based on the transaction data; and
comparing the transaction physical location vis-à-vis a physical location associated with each respective plurality of potential sponsors.

3. The computer system of claim 2, the physical location associated with each respective plurality of potential sponsors is constituted by a physical store associated with each respective plurality of potential sponsors.

4. The computer system of claim 1, the determining an affiliation level of each of the plurality of potential sponsors vis-à-vis the transaction data includes:
comparing the transaction product mix vis-à-vis product offerings of each respective plurality of potential sponsors.

5. The computer system of claim 1, the electronic payment mechanism is constituted by a credit card mechanism.

6. The computer system of claim 1, the transaction data further including customer identification data associated with the human user.

7. The computer system of claim 6, the processing, performed by the processor, further includes generating the roundme data based on the customer identification data.

8. The computer system of claim 6, the customer identification data is constituted by customer loyalty data.

9. The computer system of claim 1, the initial transaction amount is a fractional dollar amount and the reduced payment amount is a whole dollar amount.

10. The computer system of claim 1, the outputting content, unique to the selected sponsor, to the human user includes:
outputting a branding message for the selected sponsor.

11. The computer system of claim 1, the outputting content, unique to the selected sponsor, to the human user includes:
outputting a branding message for the selected sponsor, the branding message output to the human user at a point of sale (POS) at which the transaction was performed.
